(19) United States
(12) Patent Application Publication
(10) Pub. No.: US 2004/0241304 A1
(43) Pub. Date: Dec. 2, 2004

(54) Use of a chicory flour for preparing a food dough

(76) Inventors: Sebastien Bossard, Les Sorinieres (FR); Maurice Leveque, Locmine (FR); Francis Marboutin, Lamothe-Landerron (FR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/480,709

(22) PCT Filed: Jun. 12, 2002
(86) PCT No.: PCT/FR02/02017

(30) Foreign Application Priority Data
Jun. 15, 2001 (FR) 01/07862

(51) Int. Cl. A21D 13/04

(52) U.S. Cl. 426/550

(57) ABSTRACT

The invention relates in particular to using a flour obtained by milling dehydrated chicory roots to prepare a food dough for baking. According to the invention, said dough is selected from the group constituted by bread dough, Viennese pastry, and biscuit mix.

The present invention relates to the use of a flour obtained by milling dehydrated chicory roots in order to prepare a food dough and that it to be baked, and to a method of preparing food from such a dough.

Throughout the present application, the term “chicory” is used to designate so-called “large root chicory”, which is known for use, after roasting and grinding, mixed in with coffee.

Thus, U.S. Pat. No. 2,075,663 describes a method of producing chicory beans. To do this, chicory roots are dehydrated, they are then reduced to the state of a pulp and then to a flour, and the extracted liquids are mixed with the flour so as to make up a uniform mass which is subsequently compressed to give beans of various shapes.

Chicory root is well known for its diuretic virtues. It is also effective against liver complaints, constipation, and various troubles of the skin.

It is rich in mineral salts, and contains glucides, proteins, lipids, and vitamins B, C, E, and K.

It also contains a high quantity of a glucide of the fructane family, namely inulin, which is to be found in the intact state in the dried product. This compound is known to contribute to equilibrium of intestinal flora.

Patent document FR-A-2 474 053 relates to recovering inulin and fructose. Inulin is recovered from plant material and inulin is hydrolyzed into fructose. Use is made of chicory roots as plant material, which roots are chopped to form a paste.

In addition, U.S. Pat. No. 4,277,563 relates to a method of preparing fructose. Fructose is obtained from plants containing a fructose polymer such as inulin. The plant may be chicory, in particular.

The prior art shows other applications for chicory root. Thus, patent document EP-A-0 293 935 relates to an additive for stock feed which contains substances that are the result of transforming chicory roots. The transformation may be the result of enzymatic decomposition of a mash of roots that have previously been chopped and molded.

FR-A-2 165 312 relates to diet foods. In such foods, ordinary fats are replaced by paraffin oil or Vaseline. In a particular example, one of the ingredients needed for making pralines is roast chicory flour.

Document EP-A-0 850 569 relates to preparing a foodstuff for improving the equilibrium of the intestinal flora in animal or in man.

To do this, the nutritional characteristics of the inulin contained in chicory root are used in association with those of various cereals, from which a gelatinized mixture is made containing a source of starch in order to cause the bitterness provided by the sesquiterpenes contained naturally in chicory root to disappear and in order to form a matrix in which the chicory flour is included. Finally, the mixture is extruded in order to make flakes or granules.

That document relates to making a mixture that is not intended to be cooked, but that is pregelatinized (by a heating method) and then extruded. The flour is used for nutritional purposes only.

The present Applicants have discovered, surprisingly, that chicory root reduced to a flour lends itself very well to food applications, specifically to preparing a food dough for baking.

They have also discovered that using this dough containing all of the ingredients of the root has beneficial effects on products made from said food dough.

The present invention thus firstly provides the use of a flour obtained by milling dehydrated chicory roots to prepare a food dough for baking, said dough being selected from the group constituted by dough for bread, pastry for Viennese pastries, and mix for biscuits.

The botanical species used in the context of the invention are preferably Cichorium intybus L and Cichorium endivia L.

The term “food dough for baking” covers a solid or semi-liquid food dough that is to be subjected to heat treatment at a temperature greater than 150° C.

The term “dehydrated chicory roots” is used to mean dehydrated roots that have not been subjected to any prior or subsequent treatment such as roasting.

The term “Viennese pastries” is used to cover fine bakery products other than bread, this term also covering products made of puff pastry. Examples of such products include brioche and sandwich bread.

Preferably, 1% to 100% by weight of said flour is used, the percentage being expressed relative to the total weight of flour involved in the composition of the dough.

In such a percentage range, it is the nutritional qualities of chicory root that are put forward.

According to a specific aspect of the invention, the above-defined flour is used at a content of 1% to 41%.

In this percentage range, and when it is desired to make bread dough, it is the functional aspects of chicory root that are of interest, namely the nature of its specific components and its interaction with the additional flour(s) providing the balance up to 100%. In practice, this leads to an improvement in the finished product.

Finally, in a particularly preferred form of the invention, the balance (if any) of the flour up to 100% comprises wheat flour and/or triticale flour.

The invention also provides a method of manufacturing food from a food dough selected from dough for bread, pastry for Viennese pastries, and mix for biscuit mix, in which said dough is prepared, kneaded, optionally allowed to rise, and then baked at a temperature higher than 150° C., the method being characterized in that flour obtained by milling dehydrated chicory roots is used in preparing the dough.

According to particular characteristics of the method:

1% to 100% by weight of said flour is used, the percentage being expressed relative to the total weight of flour involved in the composition of dough;

1% to 41% by weight of said flour is used;

any balance up to 100% of the flour is constituted by wheat flour and/or triticale flour.

Other characteristics and advantages of the present invention will appear on reading the following detailed description of preferred embodiments given in non-limiting manner.

In order to make the flour, chicory roots are subjected to cleaning and forced-drying, preferably a few days after being harvested, so as to ensure that all of the properties of the constituents of the roots are conserved.

The dehydration is preferably performed sufficiently thoroughly to ensure that there is practically no water left in the roots. As a result the roots can be conserved for several months.

The roots can then be milled in order to obtain a flour, using any method known to the person skilled in the art.

It can be used on its own or mixed with one or more other flours.

According to the invention, it is the interaction of all of the constituents of chicory flour with the other ingredients in the dough that produces the observed improvements.

Thus, when the chicory flour is mixed with wheat flour, the improvements observed are the following in particular:

With bread, when said chicory flour is used at a content of less than 2% by weight of the wheat flour, improvements are observed in softness, in storage life, and in taste, and there is an increase in the expansion of the baked product.

In the range 2% by 5% by weight of the wheat flour used, there is an improvement in softness, in shelf life, in taste, more marked coloring of the crumb towards a brown-gray shade typical of rustic breads, and an increase in the expansion of the baked product.

In the range 5% to 15% by weight of the wheat flour used, the color of the crumb becomes very clearly marked, with a brown color typically of certain country breads, the taste becomes slightly bitter, and the content in nutritional elements is improved.

For puff pastry, when incorporated up to 5% by weight of the wheat flour used, an improvement in softness is observed, in shelf life, in taste, and it is possible to substitute a fraction of the fat normally used (depending on the quantity of chicory flour used) without spoiling the puff effect. In addition, better conservation of the crust over time is obtained and the products have better tolerance to being deep-frozen.

For fine pastries such as brioche and sandwich bread, up to 10% of weight of the wheat flour used is incorporated and improvements in softness, in shelf life, and taste are observed and it is possible to substitute some of the fat used (depending on the quantity of chicory flour used).

In addition, the baked products expand to a greater extent, has better shelf life, and the products present better tolerance to being deep-frozen.

For biscuit type products, such as shortbread, when the chicory root flour is incorporated at up to 20% by weight of the wheat flour used, there is an improvement in the softness of the finished product, it is possible to substitute some of the fat used (as a function of the quantity of chicory flour used), and better shelf life is observed.

In addition, the products are more tasty, particularly those with low fat content.

In the range 20% to 100% incorporation, the product has improved nutritional powers (increased fiber content) associated with a highly present bitter taste.

Possible uses of the flour of the invention are described below in greater detail in the field of baking and pastry cooking.

### Example 1

### Bread Making

The following were introduced into a kneader: about 970 grams of wheat flour, 10 grams of wheat vital gluten, 0.12 grams of fungal amylazes, 0.10 grams of ascorbic acid, 20 grams of chicory flour, 15 grams of yeast, 22 grams of salt, and 600 to 620 grams of water.

The preferred kneader has an oblique axis and two speeds of rotation. Under such circumstances, the dough was kneaded slowly for 5 minutes and then at high speed for 15 minutes.

The dough was then left to rise for 1 hour at 25° C.

After being weighed out and cut into lumps, it was allowed to stand so that finishing could take place during about 90 minutes, at a temperature of about 24° C. to 26° C.

The dough was then baked in traditional manner at a temperature of about 220° C., with vapor for 25 minutes to 30 minutes.

The chicory root flour imparted shelf life and softness to the bread obtained in this way. It also colored the crust of the products slightly and gave them a particular taste. The magnitude of the taste naturally depended on the percentage of chicory root flour incorporated in the dough.

### EXAMPLE 2

### Making Viennese Pastries (Brioche)

The following were introduced into a kneader: about 750 grams of wheat flour, 16 grams of wheat gluten, 200 grams of butter powder, 0.20 grams of fungal amylazes, 0.13 grams of ascorbic acid, 30 grams of chicory, 50 grams of yeast, 22 grams of salt, and 10 tepid eggs (20° C. to 22° C.).

The preferred kneader has an oblique axis and two speeds of rotation. Under such circumstances, the dough was kneaded at slow speed for 4 minutes and then at high speed for 5 minutes. 150 grams of sugar were then introduced into the dough and it was kneaded again at high speed for 15 minutes to 20 minutes.

The dough was then allowed to rise for 30 minutes at 25° C., after which it was weighed out and subdivided so as to form 400 gram loaves.

The lumps were then allowed to stand for 10 minutes to 20 minutes at ambient temperature.

After being shaped and allowed to finish for 90 minutes at 24° C. to 26° C., the loaves were baked at 180° C., with vapor, for 30 minutes.

As in Example 1, the chicory root flour in this case also provided softness and shelf life. Because of its fiber-rich composition, it enables water to be retained better in the dough. This is of particular interest when the lumps are to be deep-frozen prior to baking, as is commonly the case for pastries such as croissants or pains au chocolate On being unfrozen prior to subsequent baking, such products have a tendency to lose some of the water they contain. That phenomenon is limited by the flour of the invention, which can only be beneficial for the appearance, the consistency, and the taste of the baked products.

### EXAMPLE 3

### Making Biscuits (Shortbread)

The following were introduced into a kneader: about 590 grams of type 55 wheat flour, 410 grams of flour of the invention, 50 grams of butter, 50 grams of sugar, one egg yolk, and 10 grams to 20 grams of salt.

The preferred kneader has an oblique axis and two speeds of rotation. In which case, the dough was kneaded at slow speed for 15 minutes.

The dough was then formed into a ball and conserved at 3° C. to 4° C. for 30 minutes to 45 minutes.

After rolling the dough, the individual biscuits were cut apart and baked at 150° C. to 200° C. for 15 minutes to 25 minutes.

In this case, the chicory root flour constituted the main ingredient of the dough. It is thus its nutritional composition that is put forward.

The biscuits made in this way were rich in inulin since that constitutes more than 55% of chicory root.

As mentioned above, this natural food fiber serves to bring intestinal flora back into equilibrium, thereby contributing to improved transit.

There follow the characteristics of products in which chicory flour has been introduced, in comparison with products in which the inulin was introduced in the form of a powder.

Application fields tested: bread making and fine pastry making (sandwich bread, brioche).

The degree of weakening and the stability of the dough serve to evaluate the uniformity of the gluten lattice of a flour which is directly responsible for the suitability of the flour to be worked easily, and is also important in terms of crumb flexibility and shelf life in the finished product.

It should be observed that after adding chicory flour, the stability of the dough is significantly lengthened and the degree of weakening is reduced, likewise to a large extent. This demonstrates the ability of the lattice (to which the chicory flour has been added) to provide dough that is flexible, uniform, and stable, thus making the dough clearly better to work and providing a finished product that is clearly better in terms of softness and shelf life.

1. The use of a flour obtained by milling dehydrated chicory roots in comparing a food dough for baking, the use being characterized by the fact that said dough is selected from the group constituted by bread dough, Viennese pastry, and biscuit mix.

2. A use according to claim 1, characterized by the fact that the flour is obtained by milling roots of chicory of at least one of the following species: Cichorium intybus L and Cichorium endivia L.

3. A use according to claim 1 or claim 2, characterized by the fact that 1% to 100% by weight of said flour is used, the percentage being expressed relative to the total weight of flour entering into the composition of the dough.

4. A use according to claim 3, characterized by the fact that 1% to 41% by weight of said flour is used.

5. A use according to claim 4 or claim 4, characterized by the fact that the balance, if any, up to 100% of the flour is formed by wheat flour and/or by triticale flour.

6. A method of making food from a food dough selected from bread dough, Viennese pastry, and biscuit mix, in which said dough is prepared, kneaded, optionally allowed to rise, and then baked at a temperature greater than 150° C., the method being characterized by the fact that in preparing the dough, use is made of the flour that is obtained by milling dehydrated chicory roots.

7. A method according to claim 6, characterized by the fact that 1% to 100% by weight of said flour is used, the percentage being expressed relative to the total weight of flour entering into the composition of the dough.

8. A method according to claim 7, characterized by the fact that 1% to 41% by weight of said flour is used.

9. A method according to claim 7 or claim 8, characterized by the fact that the balance, if any, of the flour, up to 100%, is constituted by wheat flour and/or by triticale flour.
